(19) United States
(12) Patent Application Publication
(10) Pub. No.: US 2005/0088312 A1
(43) Pub. Date: Apr. 28, 2005

(54) Electronic safety flare system

(76) Inventor: John P. Fulwiler, Belton, TX (US)

Correspondence Address: David G. Henry, 900 Washington Avenue, P.O. Box 1470, Waco, TX, 76703-1470, US

(21) Appl. No.: 10/680,882

(22) Filed: Oct. 8, 2003

(51) Int. Cl. G09F 9/33

(52) U.S. Cl. 340/815.45; 340/908; 340/471

(57) ABSTRACT

A flexible electronic safe flare system which includes two LED flashing light arrays mounted on a flexible base member with attachment straps for attaching in any of a number of different orientations and configurations. Stands are described for supporting the flare system in positions and orientations for various uses, such as highway light-marking of objects or positions.

### BACKGROUND OF THE INVENTION

1. Field of the Invention

The present invention relates to safety devices, and in particular to devices useful in heightening the visibility of hazards to on-lookers.

2. Background Information

Many circumstances require that items, locations, or even persons be rendered more highly visible, if safety is to be optimized. Such circumstances are particularly prevalent in conditions of darkness, with disabled vehicles at a roadside being a classic example of the need for heightened visibility.

Incendiary flares have long been an item of choice when illuminating the location or a disabled vehicle, an accident site, or of persons working in a dangerous location vis a vis moving traffic, or in other conditions where siting things or individuals is for some reason of paramount importance. Battery operated flashlights are the most common alternatives.

The conventional approach to light-marking items or individuals as just described are not without limitations. Incendiary flares are rather quickly exhausted, represent something of a hazard when transported in a vehicle, and present a serious fire hazzard when used in certain areas with a high fire potential. Battery operated flashlights tend to be highly directional, not particularly noticeable when viewed by others at a distance, and are also rather short-lived.

### SUMMARY OF THE INVENTION

In view of the foregoing, it is an object of the present invention to provide an improved visualization aid in light-marking objects or individuals.

It is another object of the present invention to provide a visualization aid in light-marking objects or individuals which, vis a vis existing incendiary flares, flashlights, and the like, present a more highly visible light-marking effect.

It is another object of the present invention to provide a visualization aid in light-marking objects or individuals which, vis a vis existing incendiary flares, flashlights, and the like, provide an improved, re-usable item which, even on a single use basis, provides longer service life than most presently available alternatives.

It is another object of the present invention to provide a visualization aid in light-marking objects or individuals which, vis a vis existing incendiary flares, flashlights, and the like, provides a far greater breadth of contexts in which the device is safely and effectively useable.

In satisfaction of these and related objects, the present invention provides an LED-based light emitting system. The system in its preferred embodiment includes a fabric pouch-like assembly upon which two LED panels are externally mounted. A battery pack, control circuitry, and a switch for powering and actuating the LED panels resides in accessible, internal pockets. VELCRO-fastenable flaps are provides to reversibly attach the pouch-like assembly to various support structures, including several choices of stand members which are described in the specification. The flexibility of the pouch-like member, together with the flaps affords great flexibility in positioning and orienting the system for light-marking locations or individuals.

By utilizing LED-based lighting (flashing LEDs being the preferred choice), the present system has a very long service life on any given set of batteries, very high light output over almost the entire life of the batteries.

### BRIEF DESCRIPTION OF THE DRAWINGS

FIG. 1 is a perspective view of the preferred embodiment of an electronic safety flare system of the present invention.

FIG. 2 depicts the electronic safety flare system of the present invention mounted on a sawhorse type traffic barrier.

FIG. 3 depicts the electronic safety flare system of the present invention mounted on a stand specifically designed for use in the present system.

FIG. 4 depicts the electronic safety flare system of the present invention positioned over an edge of an automobile enclosure.

FIG. 5 depicts the electronic safety flare system of the present invention attached to the belt of a runner.

FIG. 6 is a perspective view of the safety flare systems of the present invention inclusive of a rigid stand for use as a roadside flare.

FIG. 7 is a perspective view of the safety flare systems of the present invention inclusive of a foldable stand for use as a roadside flare.

### DETAILED DESCRIPTION OF THE PREFERRED EMBODIMENT

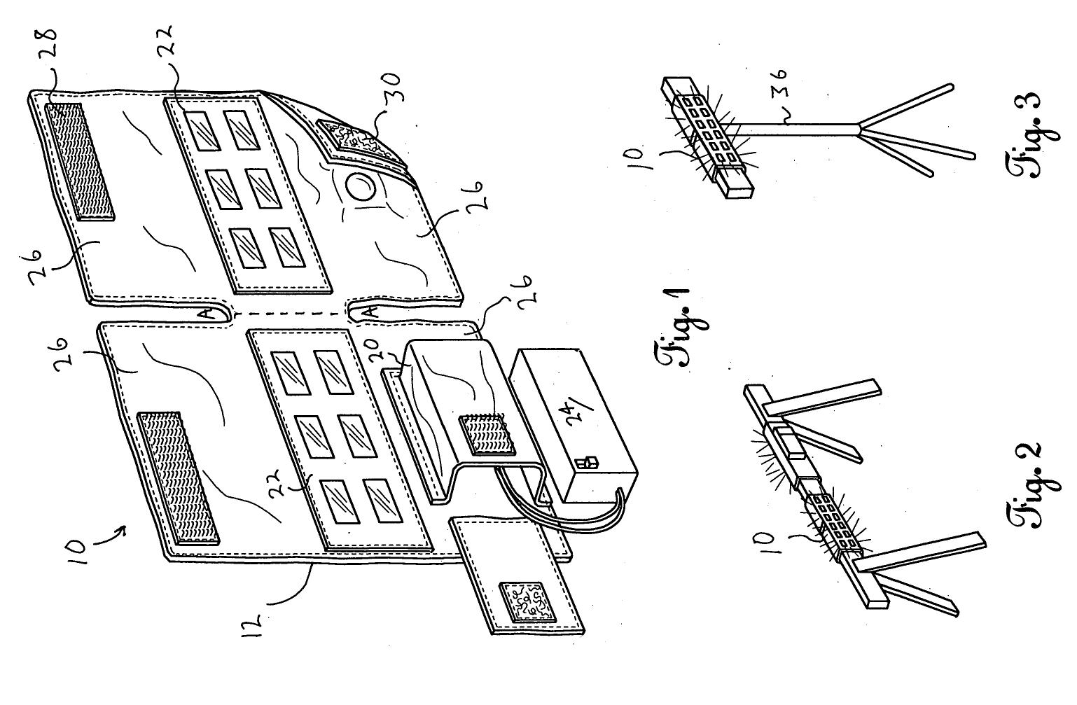

Referring to FIG. 1, the electronic safety flare system (absent any stands, which are to be discussed later) is identified generally by the reference number 10.

System 10 includes a flexible support member 12. Flexible support member 12 is, in the preferred embodiment, made of water-resistant fabric. While flexible support member 12 is primarily a unitary structure, with but a pocket 20 and light panels 22 appended, it is best to describe functional portions thereof.

Flexible support member 12 includes, in its preferred embodiment, two light support faces 14 which are surfaces areas on one side of member 12 and positioned on either side of a substantial line of symmetry A of member 12, about which flexible support member 12 can be readily bent to configure and orient member 12 as desired for any particular use (to be discussed in more detail later).

The preferred embodiment of the present invention includes two LED light panels 22 which are positioned within the areas of flexible support member 12 which are identified as light support faces 14 as depicted in FIG. 1. The preferred embodiment of the present invention utilizes arrays of flashing LEDs (together, or in combinations) with luminosity as follows: Red-500 mcd, Yellow-800 mcd, Blue-1500 mcd and/or other colors of a particular user's or designer's choice. When LEDs are used, a CMOS tyle LED driver is used to flash the LEDs at a twice per second rate in the preferred embodiment, and the unit is powered by conventional AA batteries (in the preferred embodiment) in a conventional AA battery case 24 (which resides in pocket 20 appended to flexible support member 12). It should be noted that alternative lighting options might include such things are conventional “strobe” lights, halogen lights with flashing circuitry, and other light emitting choices. However, because of the high efficiency of present LEDs when compared to present alternative lighting choices, it is believed that the LED represents the best choice at present.

In one embodiment of the present invention, either a portion of member 12, or an additional panel added thereto over the light support faces 14 portion, will be fabricated of retro-reflective material (such as is often used in night-reflected safety vests, cyclists clothing striping, etc.) and serves as a reflective supplement to the lights themselves in enhancing visibility.

While a number of options are available which would fall within the scope of the present invention, exemplary LED components and circuitry, all or a portion of which may be useful in constructing alternative embodiments of the present invention, are shown in U.S. Pat. Nos. 4,345,305, 5,149,190 and 6,515,584, the disclosures of which are here incorporated by reference.

Referring still principally to FIG. 1, “flexible envelopment tethers” 26 (essentially fabric flaps in the preferred embodiment) extend from the central portion of flexible support member 12. Envelopment tethers 26 are paired, with each having a respective pairing of hook 28 and eye 30 fastening materials (VELCRO) attached to their distal margins.

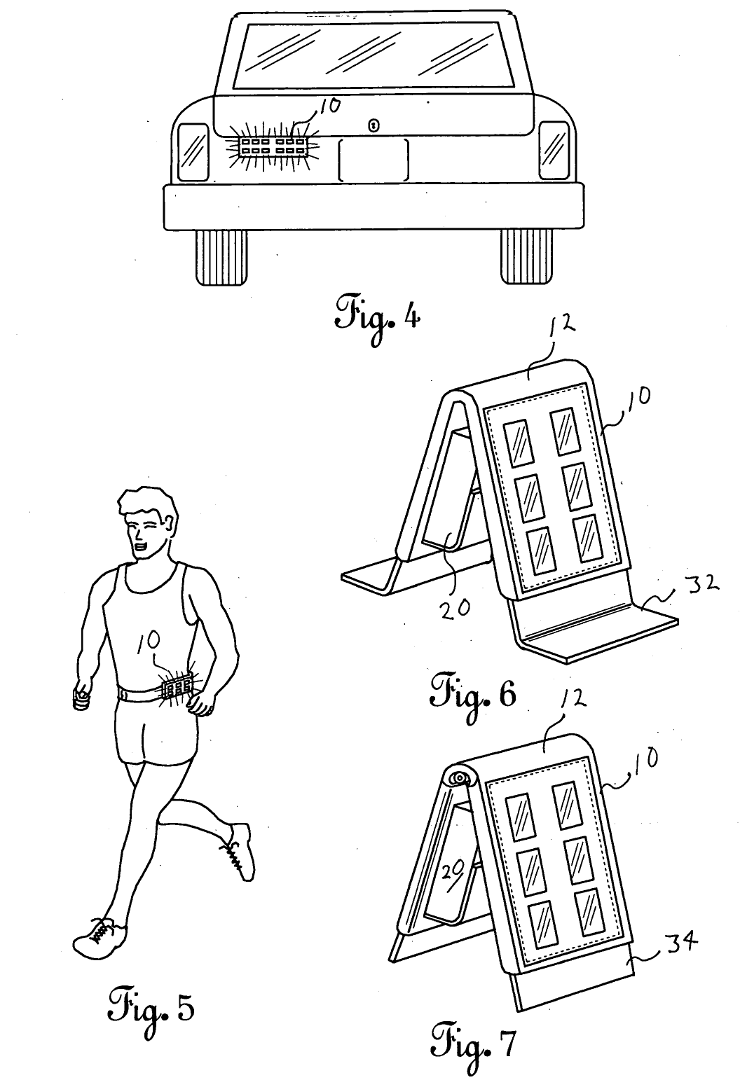

As is clear from an examination of FIGS. 2, 3, 4 and 5, the structure and constitution of system 10 affords considerable utility in a wide variety of contexts, without any additional components. System 10 can easily be adapted to attach to existing structures or items (see particularly FIGS. 2, 4 and 5), but can be supported by stands 32, 34 or 36 which are made specifically for incorporation into the present system (see particularly FIGS. 3, 6 and 7). These stands, or course, can be made of metal or plastic, depending on the intended user's preferences for weight, durability, etc.

Referring in particular to FIGS. 3, 6 and 7, stands made specifically for incorporation into the present system 10 can fulfill many needs. Stand 36 shown in FIG. 3, for example, can be used by police, fire and other public servants where particularly high visibility in a street or highway context is desirable, and consumption of trunk space and the like is not as much of a concern as might be the case with a private vehicle. On the other hand, variants of “flare stand” 32 and 34 (collapsible version) shown in FIGS. 6 and 7 would well serve any one looking to replace the conventional incendiary flares, while conserving car trunk space.

Notably, system 10 is easily attached and removed from any of the depicted mounting structures or devices, and is easily convertible between any of the depicted uses.

Because of the use of LED-based lighting as described, system 10 emits highly visible light pulses, yet consumes very little battery power per unit time, while avoiding any of the hazzards associated with incendiary flares, nor limited visibility and battery life associated with conventional flashlights. Embodiments of the present invention are light, compact, and easily stored and transported.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. An electronic safety flare system comprising:
a flexible support member, said flexible support member having a first light support face;
a first flexible envelopment tether attachable to said flexible support member;
first clasping means for reversibly securing said flexible envelopment tether in an envelopment configuration;
first light means attached to said light support face of said flexible support member;
power means for providing power to said light means; and
switching means in electrical connection with said light means and said power means for reversibly actuating said light means.

2. The electronic safety flare system of claim 1 wherein said first light means includes LED means for emitting light from said first light support face.

3. The electronic safety flare system of claim 1 wherein said first light means includes a flashing LED light means for emitting flashing light from said first light support face.

4. The electronic safety flare system of claim 1 wherein said first light means includes LED means for emitting light, which LED means includes a plurality of LEDs.

5. The electronic safety flare system of claim 1 wherein said first light means includes a flashing LED light means for emitting flashing light, which flashing LED means includes a plurality of LEDs.

6. The electronic safety flare system of claim 1 wherein said flexible support member is constructed of a fabric material, and wherein said first flexible envelopment tether comprises first and second fabric swatches fixedly connected at respective first ends to said flexible support member and respectively having situated at their second, loose ends said clasping means for reversibly securing said first and second fabric swatches in said envelopment configuration.

7. The electronic safety flare system of claim 2 wherein said flexible support member is constructed of a fabric material, and wherein said first flexible envelopment tether comprises first and second fabric swatches fixedly connected at respective first ends to said flexible support member and respectively having situated at their second, loose ends said clasping means for reversibly securing said first and second fabric swatches in said envelopment configuration.

8. The electronic safety flare system of claim 3 wherein said flexible support member is constructed of a fabric material, and wherein said first flexible envelopment tether comprises first and second fabric swatches fixedly connected at respective first ends to said flexible support member and respectively having situated at their second, loose ends said clasping means for reversibly securing said first and second fabric swatches in said envelopment configuration.

9. The electronic safety flare system of claim 5 wherein said flexible support member is constructed of a fabric material, and wherein said first flexible envelopment tether comprises first and second fabric swatches fixedly connected at respective first ends to said flexible support member and respectively having situated at their second, loose ends said clasping means for reversibly securing said first and second fabric swatches in said envelopment configuration.

10. The electronic safety flare system of claim 9 further comprising stand means for supporting said flexible support member on a ground surface for projecting light in at least a partially user positionable orientation, said stand means being sized and shaped for reversible engagement with said flexible tether member.

11. An electronic safety flare system comprising:
a flexible support member, said flexible support member having first and second light support faces;
first and second flexible envelopment tethers attachable to said flexible support member;
first and second clasping means for reversibly securing said first and second flexible envelopment tethers in envelopment configurations;
first and second light means attached respectively to said first and second light support faces of said flexible support member;
power means for providing power to said first and second light means; and
switching means in electrical connection with said first and second light means and said power means for reversibly actuating said first and second light means.

12. The electronic safety flare system: of claim 11 wherein said first and second light means include LED means for emitting light respectively from said first and second light support faces.

13. The electronic safety flare system of claim 11 wherein said first and second light means include flashing LED light means for emitting flashing light from said first and second light support faces.

14. The electronic safety flare system of claim 1 wherein said first and second light means include LED means for emitting light respectively from said first and second light support faces, which LED means include a plurality of LEDs.

15. The electronic safety flare system of claim 11 wherein said first and second light means include flashing LED light means for emitting flashing light respectively from said first and second light support faces, which flashing LED means include a plurality of LEDs.

16. The electronic safety flare system of claim 15 wherein said flexible support member is constructed of a fabric material, and wherein said first and second flexible envelopment tethers respectively comprise first and second fabric swatches fixedly connected at respective first ends to said flexible support member and respectively having situated at their second, loose ends said clasping means for reversibly securing said first and second fabric swatches in envelopment configurations.

17. The electronic safety flare system of claim 1 wherein said flexible support member is configured whereby said first and second light support faces are positioned on either side of a bendable portion of said flexible support member such that said electronic safety flare system is reversibly configurable for simultaneously projecting light in substantially opposite directions.

18. The electronic safety flare system of claim 16 wherein said flexible support member is configured whereby said first and second light support faces are positioned on either side of a bendable portion of said flexible support member such that said electronic safety flare system is reversibly configurable for simultaneously projecting light in substantially opposite directions.

19. The electronic safety flare system of claim 16 further comprising stand means for supporting said flexible support member on a ground surface for projecting light in at least a partially user positionable orientation, said stand means being sized and shaped for reversible engagement with said flexible tether member.

20. The electronic safety flare system of claim 17 further comprising stand means for supporting said flexible support member on a ground surface for projecting light in at least a partially user positionable orientation, said stand means being sized and shaped for reversible engagement with said flexible tether member.
